(19) United States
(12) Patent Application Publication
(10) Pub. No.: US 2013/0327278 A1
(43) Pub. Date: Dec. 12, 2013

(54) PET LITTER BOX DEBRIS TRAP

(71) Applicant: MATTHEW REICHERT, West Chester, PA (US)

(72) Inventor: Matthew Reichert, West Chester, PA (US)

(73) Assignee: Matthew Reichert, West Chester, PA (US)

(21) Appl. No.: 13/675,680

(22) Filed: Nov. 13, 2012

Related U.S. Application Data
(63) Continuation-in-part of application No. 29/423,987, filed on Jun. 6, 2012, now Pat. No. D689247.

(51) Int. Cl. A01K 1/01

(52) U.S. Cl. CPC A01K 1/0114
USPC 119/167

(57) ABSTRACT

The present technology provides a litter box debris trap. The litter box debris trap includes a tray and a mat. The tray has an outer barrier surrounding the outside of the tray. The mat has a plurality of film layers, including a bottom film layer and at least one removable (or upper) film layer. The bottom film layer and each of the at least one removable film layers have a tacky top surface. The mat is attached to the tray such that the outer barrier of the tray surrounds the mat. Each of the removable film layers of the mat can be peeled away from the mat to expose the tacky top surface of the film layer beneath the peeled away film layer.

### RELATED APPLICATIONS

This application makes reference to, and claims priority to U.S. Design Patent Application No. 29/423,987 filed on Jun. 6, 2012, 2012 by Matthew Reichert, titled “Litter Tray Mat.” U.S. Design Patent Application No. 29/423,987 is hereby incorporated by reference in its entirety.

### BACKGROUND

A litter box, sometimes called a sandbox, a litter tray, a litter pan, or a catbox, is an indoor waste and excretion disposal apparatus for cats and other pets that are permitted to freely roam about a home. Pets that are capable may use the litter box to relieve themselves without creating a mess inside the home of the pet owner, and without being exposed to the dangers or discomforts of the outdoors.

Litter boxes typically include a housing, such as a tray, a pan or a cage. The bottom of a litter box housing is typically filled with a layer of a loose granular litter material. The litter material helps absorb moisture and odors, and can also help satisfy a pet's instinctive desire to excrete on an easily-dug material. However, because the litter is loose and absorbent, litter material and other debris can fall from the litter box, or cling to a departing pet after using the litter box. This can result in litter debris being spread outside of the litter box and throughout the home.

### SUMMARY

The present technology generally relates to a litter box debris trap having a tray and a mat. An outer barrier surrounds the outer edge of the tray. The mat has a plurality of film layers, including a bottom film layer and at least one removable (or upper) film layer. The bottom film layer and each of the at least one removable film layers have a tacky top surface. The mat is attached to the tray such that the outer barrier of the tray surrounds the mat. Each of the removable film layers of the mat can be peeled away from the mat to expose the tacky top surface of the film layer beneath the peeled away film layer.

Another aspect of the present technology provides a method for inhibiting pets from tracking litter outside of a litter box comprising. The method includes providing a tray comprising a surrounding barrier. In certain embodiments, the tray is provided by connecting two or more tray components together. The method also includes laminating a plurality of film layers (e.g., polyethylene film) together to form a mat. Each of the film layers has a top surface with a tacky substance. The bottom surface of the mat is then attached to the tray so that the surrounding barrier of the tray surrounds the mat. The tray can then be placed near an opening in a litter box. In certain embodiments, the tray can be attached to the litter box.

Another embodiment of the present technology provides a litter box assembly. The litter box assembly comprises a litter box attached or in close proximity to a litter box debris trap. The litter box debris trap has a tray and a mat. The tray has an outer barrier surrounding the outside of the tray. The mat has a plurality of film layers, including a bottom film layer and at least one removable (or upper) film layer. The bottom film layer and each of the at least one removable film layers have a tacky top surface. The mat is attached to the tray such that the outer barrier of the tray surrounds the mat. Each of the removable film layers of the mat can be peeled away from the mat to expose the tacky top surface of the film layer beneath the peeled away film layer.

### BRIEF DESCRIPTION OF THE DRAWINGS

FIG. 1 depicts an isometric view of a pet litter box debris trap in accordance with at least one embodiment of the present technology.

FIG. 2 is a top view of the pet litter box debris trap of FIG. 1.

FIG. 3 depicts a pet litter box debris trap positioned outside of an opening of a litter box.

FIG. 4 depicts tray component used in one embodiment of the present technology.

FIG. 5 depicts two tray components mated together to form a tray in accordance with an embodiment of the present technology.

FIG. 6 depicts a tacky mat having a plurality of peel-away layers.

FIG. 7 depicts a flow diagram of a method for inhibiting pets from tracking litter outside of a litter box in accordance with at least one embodiment of the present technology.

### DETAILED DESCRIPTION

The present technology provides a debris trap for use with a pet litter box. More specifically, the present technology provides a tray having a mat with a tacky surface placed outside of a litter box. In providing the debris trap of the present technology, a pet emerging from a litter box will walk across the tacky surface of the mat, and the tacky surface can remove and/or collect litter or other debris that clings to the pet. The tacky mat has a plurality of tacky film layers laminated together. Therefore, when the top surface of the tacky mat becomes sufficiently soiled, or when the top surface of the mat has lost its tacky nature, the top layer of the mat can be peeled away and disposed, thereby exposing a new tacky surface on the mat.

The debris trap of the present technology removes litter and other debris from the paws, legs, or feet of a household pet. The item can be placed in front of litter box such that the pet must walk across the trap upon departing a litter box. The tacky surface of the mat removes litter or other debris that clings to the pet, thereby reducing the amount of litter and debris spread throughout the home. The debris trap also collects and inhibits the wide distribution of any litter or debris that may be accidentally kicked or shaken out of the litter box.

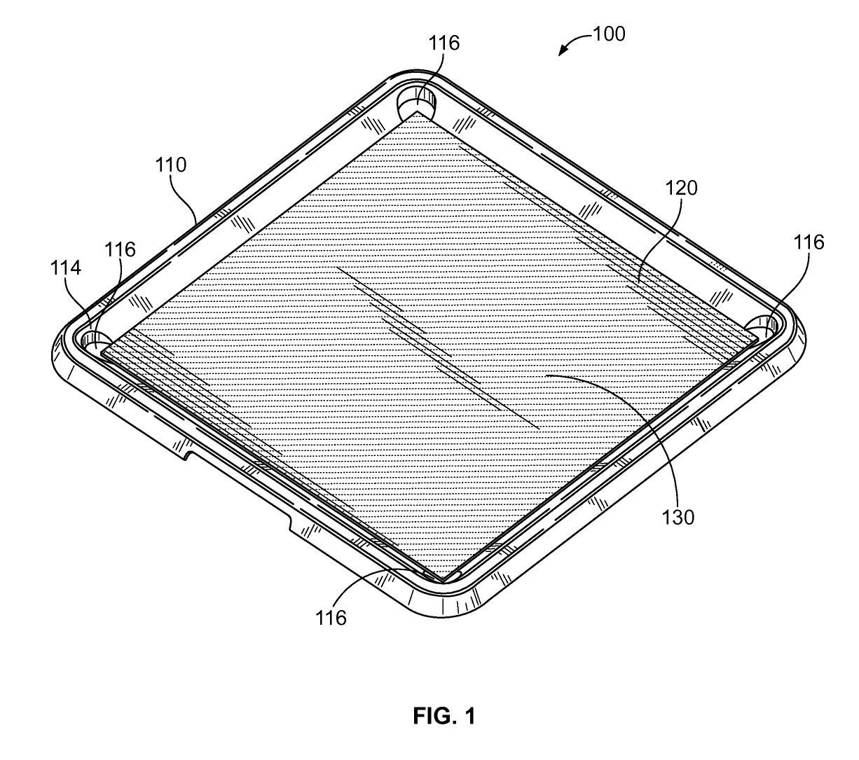

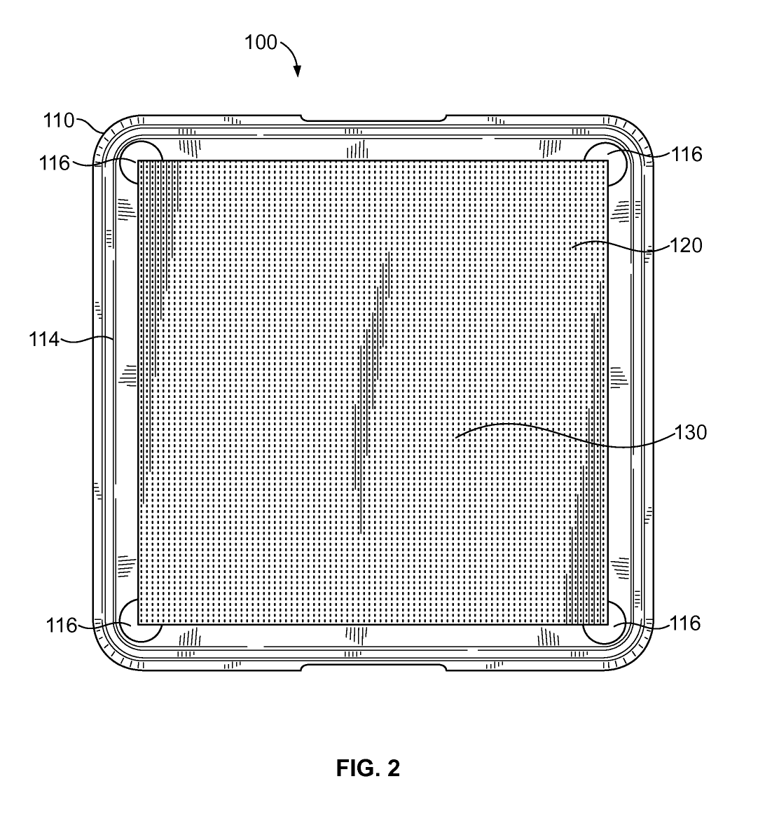

FIGS. 1 and 2 depict a debris trap 100 in accordance with at least one embodiment of the present technology. The debris trap 100 comprises a tray 110 and a tacky mat 120. The mat 120 may comprise a plurality of film layers that can be removed from one another. The top surface 130 of the tacky mat 120 is generally tacky such that it will remove and/or collect litter or other debris carried out of the litter box by a pet. In certain embodiments of the present technology, the tacky mat 120 may initially comprise a non-tacky protective film layer (not shown) on the top of the mat 120 to prevent the collection of debris when the debris trap 100 is not in use, or prior to the initial use of the debris trap 100. In this embodiment, once the debris trap 100 is put in use, the non-tacky protective film layer can be removed to expose the tacky surface 130 of the topmost layer of the tacky mat 120.

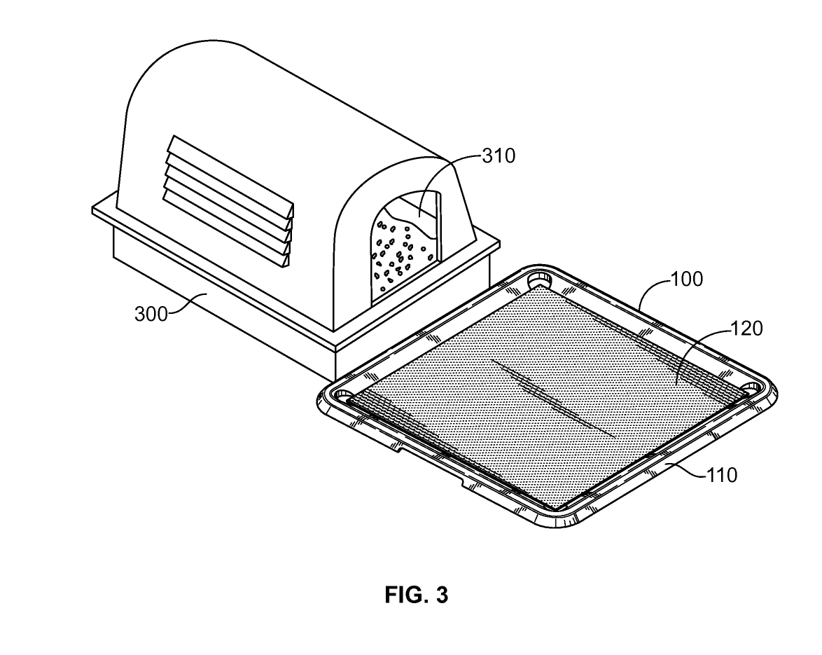

FIG. 3 depicts the litter debris trap 100 used in connection with a pet litter box 300. As depicted in FIG. 3, the litter debris trap 100 is positioned outside of an opening 310 in the litter box 300, such that any pet emerging from the litter box 300 will have to walk across the trap 100, in particular, the tacky surface 130 of the tacky mat 120, after emerging from the litter box 300. In this manner, the tacky top surface 130, will attract and collect litter and other debris that has clung to the pet before the pet continues on to walk throughout the house. In certain embodiments of the present technology, the litter debris trap 100 may be configured to attach to or on the litter box 300. This connection may be accomplished, for example, via a snap-fit connection with the litter box 300, or by another attachment method, such as tape, screws, nails, hooks and loops or magnets. By attaching the litter debris trap 100 to the litter box 300 the litter debris trap 100 can assure that it remains in close proximity to the opening 310 of the litter box 300 even if the debris trap 100 is kicked or moved. Attaching the debris trap 100 to the litter box 300 also helps inhibit the pet's presence and movement from causing the debris trap 100 to slide away from the litter box 300.

Referring again to FIGS. 1 and 2, the tray 110 has a surrounding barrier 114, which may be a wall, a ramp, a slope or other elevation. The surrounding barrier 114 and/or the general shape of the tray 110 is designed to keep litter and debris within the debris trap 100 if the trap is moved or kicked. In certain embodiments, the surrounding barrier 114 guides litter debris landing near the edge of the try onto the tacky mat 120. Alternatively or additionally, the tray 110 may be a bowl or concave in shape, such that the outer edge of the tray 110 is elevated to serve as the surrounding barrier 114. The tray 110 can also have one or more recessed portions 116 such as a carve out, a slot, a cup, a groove or a hole in various locations of the tray 110 (e.g., in the corners of a rectangular tray). These recessed portions 116 allow for the entire tacky mat 120 to lie flat on the tray while still being surrounded by barrier 114. The recessed portions 116 provide a region that allows a user to easily install the tacky mat 120 onto the tray, and to grab the corners of the tacky mat 120 for removal of the individual film layers.

The tray 110 may be a variety of shapes and sizes, depending on the particular use of the debris trap 100. For example, the tray 110 may be of a rectangular, square, trapezoidal, oval or other shape. The tray 110 may also be provided in a variety of colors and appearances, such as white, clear, black or black, for example, to provide different decorative looks or for functional purposes. For example, trays 110 may be provided in various colors to correspond to various sizes or uses of the debris trap 100. In this manner, a tray 110 designed to be used with a cat litter box may be sold in one color (e.g., white), whereas a tray 110 designed to be used with a birdcage may be sold in another color (e.g., yellow), to make for easy distinction between the products, for example. In certain embodiments of the present technology, the tray 110 can be a rectangle having dimensions of between 10 to 20 inches on one side and between 15 to 25 inches on another. For example, in certain embodiments of the present technology, the tray 110 has dimensions of about 16¼″×20¼″. In certain embodiments of the present technology, the tray 110 may also comprise one or more handles to make it easier for a user to pick up and move the tray 110 around.

The tray 110 can be made of a number of materials, such as polypropylene or plastic, metal, cardboard, ceramic or glass. In certain embodiments, the tray 110 can be coated with or made from an anti-microbial material. In addition, the tray 110 can include pads (e.g., rubber or foam pads) on the bottom surface of the tray to increase friction between the tray 110 and the ground to inhibit the debris trap 100 from sliding far from the litter box 300.

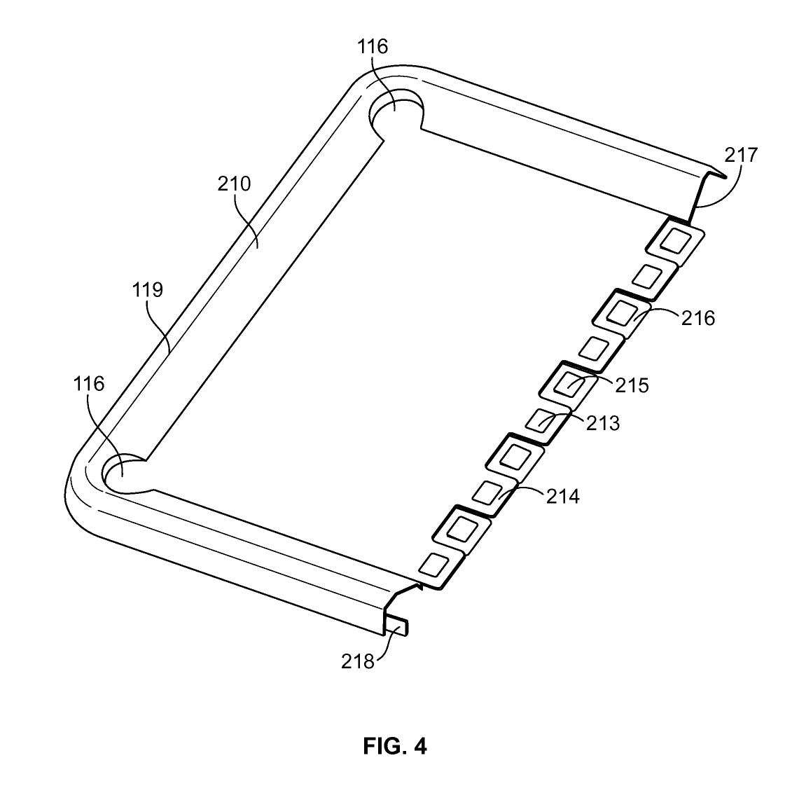

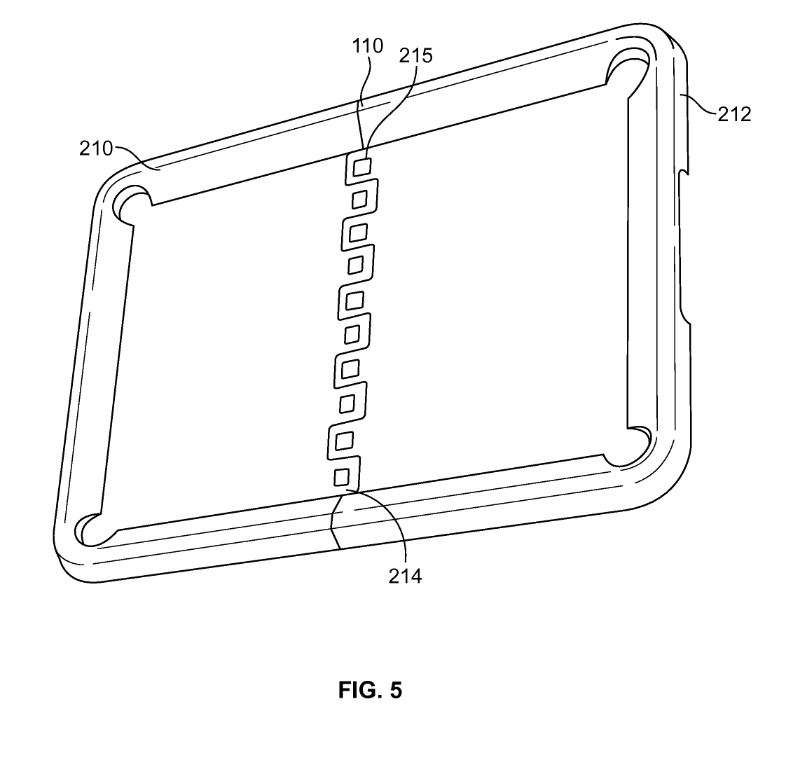

As described above, the tray 110 of the debris trap 100 can be a single solid piece. However, in certain embodiments of the present technology, it may be useful to provide a tray 110 that is made of two or more connectable components. In this manner the debris trap 100 can be broken down for easier storage, packaging and transportation, or display purposes, for example, on a store shelf. FIGS. 4 and 5 depict a tray 110 and tray components (210 and 212) that can be assembled to form a tray 110. FIG. 4 depicts tray component 210 disassembled from its mating component. Tray component 210 constitutes approximately one half of the tray 110, and includes a barrier portion 114 and recessed portions 116. The tray component 210 comprises a mating edge 217 that is adapted to connect or attach to a similar mating edge on a corresponding component. The mating edge 217 may be adapted (as shown in FIGS. 4 and 5) for mating with a tray component that is identical or virtually identical to the tray component 210 itself. Tray component 210 may have one or more outer tabs 218 projecting from the mating edge 217 at the barrier portion 114 of the tray component 210. In this manner, outer tab 218 can be adapted to connect with a corresponding mating portion (e.g., a slot, hole or groove) on the barrier portion 114 of the mating tray component 212.

In certain embodiments, a series of edge tabs (214 and 216) extend from the tray component 210 along the mating edge 217. The edge tabs include female edge tabs 214 having a female mating portion 213, which may be a slot, hole or groove, and male edge tabs 216 having a male mating portion 215, which may be a ramp, tab, riser, or other protrusion. The male mating portions 215 of the male edge tabs 216 are configured to fit snugly inside of the female mating portions 213 if the female edge tabs 214 of a second tray component 212, to provide a secure, snap-fit connection. The edge tabs (214 and 216) along the mating edge 217 may alternate among male tabs edge tabs 126 and female edge tabs 214 along the mating edge 217 as depicted in FIG. 4, but various other patterns or configurations of male edge tabs 216 and female edge tabs 214 can be used. The edge tabs (214 and 216) allow the tray component 210 to be attached to a second tray component 212, which may be identical or virtual identical to the tray component 210 itself.

The edge tabs 214 can project upward or downward at a slight angle, and bear a certain degree of flexibility to allow for the two tray components (210 and 212) to mate together in a snap-fit fashion. As shown in FIG. 5, when the two tray components 210 and 212 are assembled together, the male mating portions 215 of the male edge tabs 216 project up through the female mating portions 213 of the female edge tabs 214. To separate the tray components 210 and 212, the protrusions 215 can be depressed slightly as the tray components (210 and 212) are pulled apart. This allows the tray to be broken down into smaller components for easy storage or display.

FIGS. 1-4 depict the tray 110 as a square or rectangle shape, but in certain embodiments of the present technology the tray 110 may assume another shape or form. For example, the tray 110 can be assembled in such a manner that it surrounds two or more sides of a litter box. For example, the tray component 210 may have more than one mating edge 217 such that more than two tray components 210 can be connected together to form an L-shape for surrounding two sides of a litter box, a U-shape for surrounding three sides of a litter box, or even a donut shape to surround the entirety of a litter box. In this manner, a litter box need not have a cover with an opening to guide the pet onto the debris trap 100. Rather, the user may place an uncovered litter box in a corner, against a wall, or even in the center of a room and surround the litter box with the debris trap of the present technology.

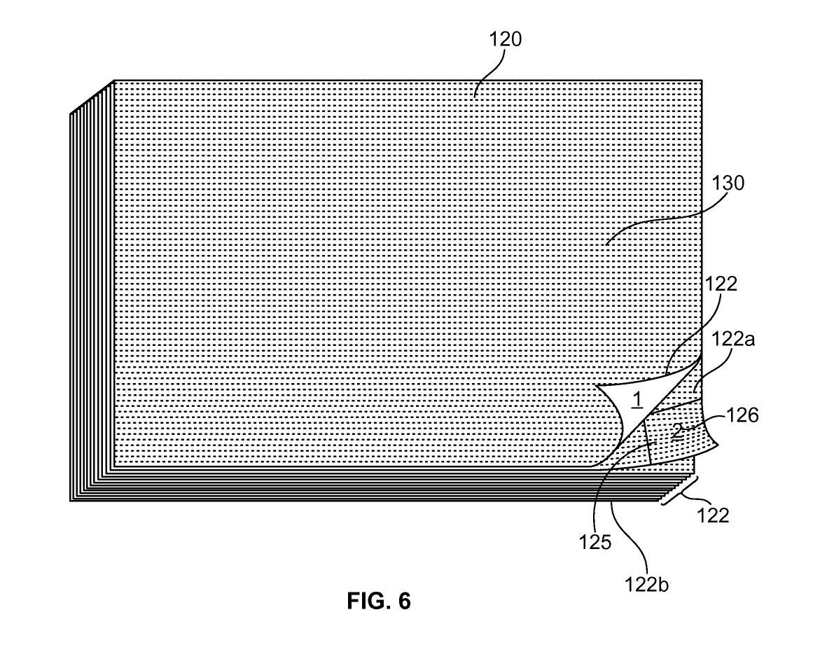

FIG. 6 depicts the tacky mat 120 separate and apart from the tray 110 of the debris trap 100. As shown, the tacky mat 120 comprises multiple film layers 122 including a plurality of removable layers 122a and one bottom layer 122b that are laminated together. The film layers 122 are made of a thin, flexible material, for example, a polyethylene material (LPDE) and can vary in thickness. For example, in certain embodiments, the film layers can range from 0.035 to 0.05 millimeters or from about 1 to 2 mils (1 mil= 1/1000^{th} of an inch), but the thickness can be greater or less than this range depending on the particular use. The mat 120 may vary in size, but is designed to fit within the surrounding barrier 114 of the tray 110. For example, where the size of the tray 110 is 16¼″×20¼″, the mat may be about 12¼″×16¼″. The tacky mat 120 can also come in various colors, for purposes of providing decorative looks or for purposes of distinction, for example.

In certain aspects of the present technology, the film layers 122 are coated with a tacky substance so that the top-most exposed surface 130 of the tacky mat 120 maintains a tacky quality. For example, the film layers 122 can be coated with a water-borne acrylic adhesive, or another high tack adhesive that provides a sufficiently tacky surface, such that the tacky mat 120 removes and collects litter and debris from a pet walking across the debris trap 100. In certain aspects of the present technology, the tacky substance or the tacky surface 130 of the mat is sufficiently tacky to remove litter from the paws of a cat when a cat walks across the tacky surface 130. That is, when a cat emerging from a litter box has litter or debris clinging to its paws, the tacky surface 130 of the mat 120 is sufficiently tacky to attract and remove at least a portion of the litter or debris from the cat's paws.

The film layers 122 of the tacky mat 120 are laminated together such that each layer 122 can be readily peeled away and removed from the tacky mat 120. Accordingly, the adhesive has properties that allow the layers 122 to be peeled away and removed from the mat 120 with relative ease, while also leaving behind a surface 130 on the exposed layer that is sufficiently tacky.

When top surface 130 of the tacky mat 120 becomes sufficiently soiled, the user may remove the top removable layer 122a by peeling it away from the mat 120, thereby exposing the tacky surface 130 of a subsequent layer 122. Because the film layers 122 of the tacky mat 120 are laminated together, each tacky surface 130 remains protected by the layers above it. Thus, there is no need for each layer 122 of the tacky mat 120 to have a separate protective liner layer. Accordingly, the present technology provides a simple and efficient way to clean and remove litter and debris from the debris trap 100.

When all the layers of the tacky mat 120 have been removed, a new tacky mat 120 can be attached to the tray 110. The bottom layer 122b of the tacky mat 120 can be attached to the tray 110 via an adhesive on the bottom surface. The tacky mat 120 may originally include a protector layer on the bottom surface 122b that, once removed, exposes an adhesive that allows for proper attachment to the tray 110. The tacky mat 120 can be rolled onto the tray 110 in a manner that minimizes bubbles and wrinkles between the tacky mat 120 and the tray 110. In certain embodiments of the present technology, the adhesive on the bottom surface of the tacky mat 120 may be stronger than the adhesive on the top surfaces 130 of the film layers to assure that the tacky mat 120 remains firmly in place on the tray 110. However, the degree of strength of the adhesive on the bottom of the tacky mat 120 can vary depending on the intent of the use. Alternatively, in certain embodiments, the tacky mat 120 may attach to the tray 110 without using adhesive. For example, tacky mat 120 can attach to the tray 110 via an adhesive tape, a hook and loop fastener (i.e., Velcro), pins, hooks, snap-fasteners or tie-straps. In certain embodiments of the present technology, the tray 110 can be scored with etchings, carvings or other markings to assist in the alignment and placement of the mat 120 on the tray 110. For example, the tray 110 may have etchings or markings that outline the shape of the tacky mat 120 configured for attachment to the tray 120. This outline can help a user to properly center and place the tacky mat 120 onto the tray 110 without having the tacky mat 120 extend over the edges of the tray 110 or onto the surrounding barrier 114.

Certain embodiments of the present technology may provide a tacky mat 120 that has a protector liner layer on the topmost film layer 122 in order to protect the tacky surface 130 of the top film layer 122. Once the new mat is installed onto the tray, the protector liner layer can be removed and the debris trap 100 can be put into use. This protector liner layer prevents the top film layer 122 from collecting dust, dirt, and debris, and otherwise losing its tacky quality before it is installed for use on the debris trap 120.

The number of film layers 122 in the tacky mat 120 can vary, and there is no limit to the number of film layers 122 that can be used by an individual tacky mat 120. The number of layers 122 can vary depending on the size and shape of the tray 110 used with the tacky mat 120. For example, where the tacky mat 120 is intended to work with a tray 110 that has a shallow surrounding barrier 114, it may be suitable to use a smaller number of film layers 122 in the tacky mat 120 (e.g., 2-30 film layers). In other embodiments, for example, where a tray having a higher surrounding barrier 114 is used, it may be convenient to use a tacky mat 120 that has a higher number of layers 122 (e.g., 15-100 film layers) so that the tacky mat 120 can go longer without needing to be replaced. Certain embodiments of the present technology can use a tacky mat 120 with about 15 to 30 film layers 122, however, it may be useful to provide a tacky mat 120 that has more film layers 122, such 50, 100 or 200 film layers 122 depending on the intended use. Alternatively, certain embodiments of the present technology may employ fewer film layers 122, such as 10, 5 or even 2 film layers 122, for example.

In certain embodiments of the present technology, the removable film layers 122 of the tacky mat 120 have a gripping portion 125, as depicted in FIG. 6. The gripping portion 125 may be a small region of the removable film layer 122 that has no adhesive. In this manner, because the gripping portion 125 of the film layers 122 do not adhere to the other layers of the tacky mat 120, a user can readily discern and grab each of the film layers 122 separately at the gripping portion 125. This allows the user to readily grab and peel away the top film layer of the tacky mat 120 for disposal when it becomes soiled. In certain embodiments, the gripping portion 125 may be marked with indexed numbers 126 that identify each film layer 122 of the tacky mat 120. The indexed numbers 126 may count upwards, such that the bottom layer 122b has a higher value than any of the removable layers 122a. Alternatively, the indexed numbers 126 may count downwards such that the indexed number 126 represents the number the number of film layers 122 remaining in the tacky mat 120. In this manner, a user can keep track of the life of the tacky mat 120 and take measures to obtain a new tacky mat 120 for replacement before the bottom layer 122b needs to be disposed.

In certain embodiments of the present technology, the tacky mat 120, and/or the film layers 122 of the tacky mat 120 are made from or coated with an anti-microbial material. The anti-microbial material can help to disinfect the surfaces of the tacky mat 120 and the debris trap 100 so that germs and other contaminants are not spread throughout the house.

In use, the debris trap 100 of the present technology can be placed outside the opening or any entry edge to a pet litter box. When a pet emerges from the litter box, either via an opening or otherwise, the pet will walk across the debris trap 100. A tacky surface 130 on the tacky mat 120 of the debris trap 100 will attract and collect litter, dirt and other debris that may be clinging to the pet, thereby preventing the disbursement of the debris throughout the house. After the tacky surface 130 of the tacky mat 120 becomes sufficiently soiled, the user can peel away the top film layer 122. Because the film layers 122 of the tacky mat 120 are laminated together, removing the soiled film layer will expose a clean, yet tacky surface on the subsequent film layer. Accordingly, additional protector liner layers are not needed for each individual film layer 122 of the mat 120. This makes the process of keeping the debris trap 100 clean simple and easy, as only one film layer (i.e., the film layer that is peeled away) is removed to expose the next tacky surface 130 of the tacky mat 120. Because the tray 110 can be made of a light weight plastic material, the debris trap 100 of the present technology is readily moveable and transportable. Therefore, a user can easily take the debris trap 100 to a trash can to peel away and easily dispose a soiled film layer. Additionally, the surrounding barrier 114 or otherwise concave shape of the tray 110 helps to keep the litter and debris contained and prevents the debris from falling off the edge of the debris trap 100 onto the floor of the house.

As noted above, the debris trap 100 of the present technology can be used in connection with a pet litter box; however, the present technology can also be used in other situations. For example, the debris trap 100 can be designed to be placed beneath a dog door (i.e., “doggie door”) to attract and collect mess brought by a dog entering a house from the outdoors. Additionally, the debris trap 100 can be placed under a hamster, gerbil, guinea pig, or mouse cage, or beneath a birdcage to collect debris. The debris trap 100 can rest under or outside of the cage to collect debris and other waste that falls onto and collects on the trap. Once the debris trap 100 becomes sufficiently soiled, the user can remove the debris trap 100, peel-away and dispose the topmost layer, and then replace the trap underneath the cage.

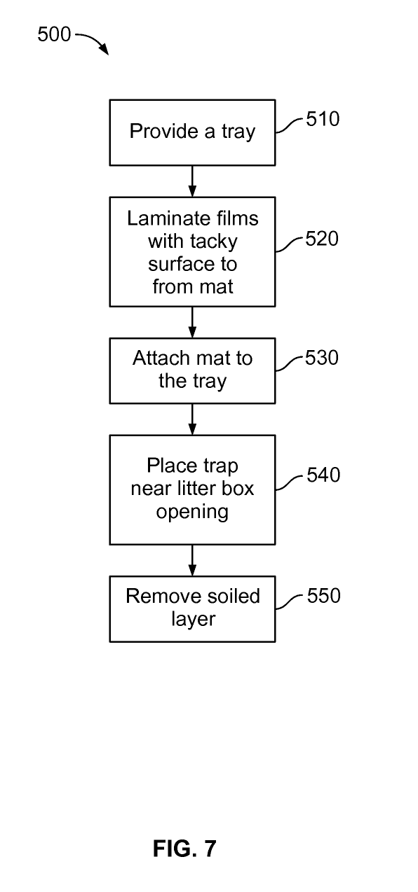

The present technology also provides methods for inhibiting pets from tracking litter outside of a litter box. FIG. 7 depicts a flow diagram of method 500, which includes providing a tray at step 510. The tray can be, for example, the tray 110 depicted in FIGS. 1-6 and described herein. The step of providing a tray 510 may include the sub-step of assembling or coupling two or more components of a tray (e.g., components 210 and 212) together to form a tray. Certain aspects of the present technology may include the step of providing etchings, carvings or other markings on the tray in order to assist a user in the alignment and placement of the mat on the tray (see step 530). For example, the tray can be scored with etchings or markings that outline the shape of the mat so that a user can simply align the mat with the markings to assure proper centering and placement of the mat onto the tray.

At step 520, a plurality of films or film layers, each having a tacky surface, are laminated together to form a tacky mat (e.g., tacky mat 120 depicted in FIGS. 1-3 and 6 and described herein). The tacky mat has a bottom film layer and at least one removable film layer such that each of the removable film layers can be peeled away to expose the tacky top surface of another film layer. In certain embodiments of the present technology, the film layers can be coated with a tacky substance before or during the lamination process. For example, the films may be coated with a water-borne acrylic adhesive. Additionally, the films may be coated with an anti-microbial coating. Though the method 500 of FIG. 7 depicts step 510 occurring before step 520, it should be understood that the present technology is not so limited because steps 510 and 520 occur separately from one another. In other words, the present technology also includes methods where step 520 can also be performed before or at the same time as step 510.

Next, the tacky mat is attached to the tray at step 530 via the bottom layer of the mat. In certain embodiments, the bottom surface of the mat is coated with an adhesive that allows the tacky mat to be attached to the tray. For example, the tacky mat may originally include a protector layer on the bottom surface of the mat that, once removed, exposes an adhesive that allows the tacky mat to be attached to the tray. The tacky mat can be rolled onto the tray in a manner that minimizes bubbles and wrinkles between the tacky mat and the tray. Alternatively, in certain embodiments, the tacky mat can be attached to the tray via adhesive tape, a hook and loop fastener (i.e., Velcro), pins, hooks, snap-fasteners or tie-straps.

At step 540 the debris trap is placed near the opening or exit edge of the litter box. The tray can be placed outside of the litter box in a manner that assures that a pet leaving the litter box will step onto the debris trap. This allows the debris trap to collect litter and other debris that cling to the pet emerging from the litter box. In certain embodiments of method 500, the debris trap may be attached or connected to a litter box to prevent the separation of the litter box and the debris trap, and to ensure that a pet emerging from the litter box must walk across the debris trap upon exiting. For example, the litter box and the debris trap may be designed such that the debris trap can be attached to the litter box via a snap-fit connection.

At step 550 a soiled film layer from the tacky mat of debris trap is removed. This can be done by peeling away the top film layer of the tacky mat to expose another film layer having a tacky surface. For example, a user may pick up the tray and carry it over to a trash can, peel away the soiled layer and dispose of it in the trash can. The user can then return the tray to the previous location outside of the litter box.

The present technology has now been described in such full, clear, concise and exact terms as to enable any person skilled in the art to which it pertains, to practice the same. It is to be understood that the foregoing describes preferred embodiments and examples of the present technology and that modifications may be made therein without departing from the spirit or scope of the invention as set forth in the claims. Moreover, it is also understood that the embodiments shown in the drawings, if any, and as described above are merely for illustrative purposes and not intended to limit the scope of the invention. As used in this description, the singular forms “a,” “an,” and “the” include plural reference such as “more than one” unless the context clearly dictates otherwise. Where the term “comprising” appears, it is contemplated that the terms “consisting essentially of” or “consisting of” could be used in its place to describe certain embodiments of the present technology. Further, all references cited herein are incorporated in their entirety.

1) A litter box debris trap comprising:
a tray having an outer barrier;
a mat having a plurality of film layers, the plurality of film layers comprising a bottom film layer and at least one removable film layer, the bottom film layer and each of the at least one removable film layers having a tacky top surface;
wherein the mat is attached to the tray such that the outer barrier of the tray surrounds the mat, and further wherein each of the removable film layers of the mat can be peeled away from the mat to expose the tacky top surface of another film layer.

2) The litter box debris trap of claim 1, wherein the mat is attached to the tray with an adhesive on a bottom surface of the bottom film layer.

3) The litter box debris trap of claim 1, wherein the film layers of the mat are laminated together.

4) The litter box debris trap of claim 1, wherein the film layers are a polyethylene film.

5) The litter box debris trap of claim 1, wherein the film layers are coated with a tacky substance.

6) The litter box debris trap of claim 5, wherein the tacky substance is a water acrylic adhesive.

7) The litter box debris trap of claim 1, wherein the tacky substance is sufficiently tacky to remove litter from the paws of a cat.

8) The litter box debris trap of claim 1, wherein the mat comprises between fifteen to thirty film layers.

9) The litter box debris trap of claim 1, wherein the tray is configured for attaching to a litter box.

10) The litter box debris trap of claim 1, wherein the tray comprises a first component and a second component, wherein the first component is adapted to removably connect to the second component to form the tray.

11) The litter box debris trap of claim 1, wherein each of the film layers further comprise a gripping portion with no adhesive or tacky substance.

12) The litter box debris trap of claim 11, wherein the gripping portion comprises an index number indicating at least one of the number of laminated layers remaining in the mat, or the number of layers that have previously been peeled away from the mat.

13) The litter box debris trap of claim 1, wherein the outer barrier of the tray is a sloped or concave surface shaped to guide litter debris landing near the edge of the try onto the mat.

14) The litter box debris trap of claim 13, wherein the outer barrier comprises a carved out portion to allow the mat to lie flat on the tray.

15) A method for inhibiting pets from tracking litter outside of a litter box comprising the following steps:
providing a tray comprising a surrounding barrier laminating a plurality of film layers together to form a mat, each of the film layers having a top surface with a tacky substance;
attaching the bottom surface of the mat to the tray such that the surrounding barrier surrounds the mat; and
placing the tray near an opening of a pet litter box.

16) The method of claim 15, further comprising the step of attaching the tray to the pet litter box.

17) The method of claim 15, further comprising the step of removing a soiled film layer from the mat to expose a tacky surface of another film layer.

18) The method of claim 15, wherein the step of providing a tray includes the additional step of assembling two components of a tray together.

19) The method of claim 15, wherein the film layers are a polyethylene film.

20) A litter box assembly comprising:
a litter box; and
a litter box debris trap comprising:
a tray having an outer barrier;
a mat attached to the tray having a plurality of film layers, the plurality of film layers comprising a bottom film layer and at least one removable film layer, the bottom film layer and each of the at least one removable film layers having a tacky top surface;
wherein the litter box debris trap is attached to the litter box, and further wherein each of the removable film layers of the mat can be peeled away from the mat to expose the tacky top surface of another film layer.
